(19) United States
(12) Patent Application Publication
(10) Pub. No.: US 2008/0162165 A1
(43) Pub. Date: Jul. 3, 2008

(54) Method and system for analyzing non-patent references in a set of patents

(76) Inventors: Herb Jiang, Sinjhuang City (TW); Jen-Diann Chiou, Taipei City (TW); Jerry Tang, Taipei City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/648,004

(22) Filed: Dec. 29, 2006

(51) Int. Cl. G06Q 99/00

(52) U.S. Cl. 705/1

(57) ABSTRACT

A method for analyzing cited references cited in a patent set comprising two or more patents. The method comprises: parsing each cited reference cited by each patent to determine a respective title of each respective cited reference; storing the title of each cited reference and the cited reference in a cited reference database, where the cited reference database links the respective title with the respective cited reference; counting the occurrence of each cited reference in the cited reference database; and displaying the title of the cited reference with the highest count.

### FIELD OF THE INVENTION

The method and system disclosed relate to the field of patent analysis, and more specifically, a system for and method of analyzing a patent portfolio to determine the importance of a cited reference.

### BACKGROUND

In the past, the analysis of patent data was limited to the relationship between patents, for example, continuations or divisionals, and the creation of citation trees illustrating the relationship of cited patents. But the relationship between a patent and other references of the patent, such as journals, papers, and articles is less discussed and analyzed. Because of this deficiency in recognizing and analyzing the importance of cited technical documents other than cited patents, users could only easily access and reference the patent prior-art, but not other cited references.

While most patent databases, such as those found on the web sites of the U.S. Patent and Trademark Office and the European Patent Office hyperlink from a viewed patent to cited patent documents, non-patent cited documents are not hyperlinked. Unfortunately, among the documents cited on the face of a patent, non-patent documents are very common. Although the format of non-patent documents are usually the same as the format of papers and journal, users never had an easy method to find the cited non-patent documents easily. One hindrance is because the format of the author and title in an electronic patent document is inconsistent.

Additionally, patent analysis techniques overlook the importance of non-patent cited prior art on the face of the patent document. Not only does this lead to the problem noted above, that links between patents and non-patent references are difficult to find or non-existent, but also that patent analysis does not consider the value of the cited non-patent prior art. No existing techniques examine the frequency with which non-patent prior art may be cited within a set of patents to be analyzed. Thus, the importance of particular non-patent prior art is missed. For example, the academic, technical, and financial value of particular researchers and organizations is not fully appreciated absent a study of the frequency of citation of non-patent cited art within patents.

The present invention addresses the above problems and is directed to achieving at least one of the above stated goals.

### SUMMARY

A method for analyzing cited references cited in a patent set comprising two or more patents is provided. The method parses each cited reference cited by each patent to determine a respective title of each respective cited reference. The method stores the title of each cited reference and the cited reference in a cited reference database, where the cited reference database links the respective title with the respective cited reference. The method counts the occurrence of each cited reference in the cited reference database, and displays the title of the cited reference with the highest count.

In accordance with a further embodiment, a system for analyzing cited references cited in a patent set comprising two or more patents is provided. The system comprises a memory and a processor coupled to the memory. The processor is operable to: parse each cited reference cited by each patent to determine a respective title of each respective cited reference; store the title of each cited reference and the cited reference in a cited reference database, where the cited reference database links the respective title with the respective cited reference; count the occurrence of each cited reference in the cited reference database; and provide the title of the cited reference with the highest count.

The foregoing summarizes only a few aspects of the invention and is not intended to be reflective of the full scope of the invention as claimed. Additional features and advantages of the invention are set forth in the following description, may be apparent from the description, or may be learned by practicing the invention. Moreover, both the foregoing summary and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate a system consistent with the principles of the invention and, together with the description, serve to explain the principles of the invention.

FIG. 1 is a flow-chart of a method of analyzing a patent set consistent with the present invention.

FIG. 2 is a flow-chart of a method of linking a reference library consistent with the present invention.

FIG. 3 is a flow-chart of a character matching method consistent with the present invention.

FIG. 4 is a block diagram of a patent analysis platform consistent with the present invention.

### DESCRIPTION

A patent analysis platform is described herein. The patent analysis platform may provide the ability to receive a set of one or more patents and link the cited non-patent prior art to the actual non-patent prior art that may be found in one or more networked databases. Thus, the non-patent prior art can be readily viewed or retrieved, simply and efficiently, while reviewing the patent document. Additionally, a patent analysis platform consistent with the principles of the present invention may created a database of cited non-patent prior art and analyze the database to perform statistical analysis on the database contents. For example, the statistical analysis may include counting the number of times each non-patent prior art reference is cited with the set of patent and providing the sums to a user. Thus, a user may know which non-patent prior art is cited the greatest number of times, or which author is cited the most, within a set of patents. As will be understood, the set of patents may comprise a set or subset of patents within a patent portfolio of one or more companies, or may include any patents that a user wishes to analyze. In addition, the analysis is not limited to patents, but may also be performed on published, or “laid open,” patent applications. Thus, the patent set may include any combination of patent or published applications.

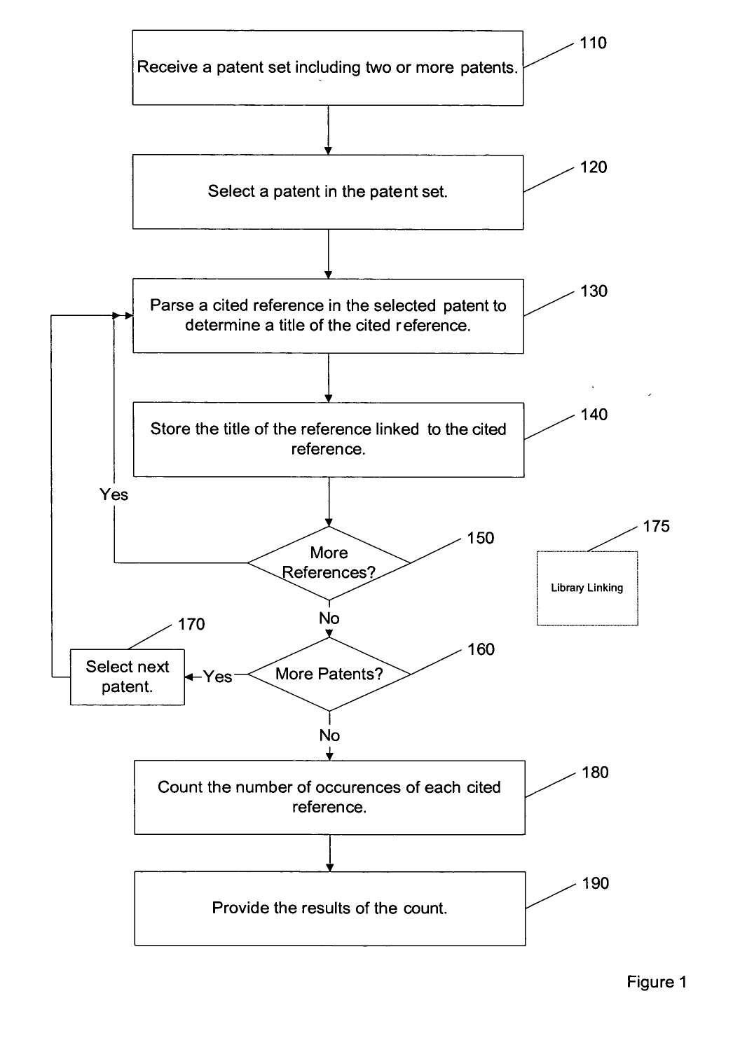

FIG. 1 is a flow-chart of a method of analyzing a patent set consistent with the present invention. Initially, a set of patents may be received (stage 110). The set of patent, as noted above, may be a patent portfolio of a company. It may also be a set of patents from one or more classification areas for one or more companies. After reading this description, one skilled in the art will appreciate the various ways that a patent set may be created. In addition, patent refers to both patents and published patent applications. After receiving the patent set, a patent in the patent set is selected (stage 120).

A first non-patent cited reference is parsed to determine a title of the reference (stage 130). Parsing may be accomplished by the following methodology. The non-patent cited reference comprising a string of characters. Initially, long spaces—two or more adjacent spaces—are removed from the character string. If author data is found in the reference, it is removed. The character sting is broken into one or more sub-strings based on the location of commas within the character string. Next, each sub-string in the remaining character string is analyzed to determine if numerical data is present in the sub-string, and, if so, the sub-string may be removed. Thus, volume, year, and page number information may be removed from the character string. Each sub-string is also analyzed to determine if a journal name is present, and, if so, the sub-string is removed. The title of the non-patent cited reference may be determined as the longest sub-string because the longest sub-sting is the title in most cases. Those skilled in the art will appreciate that other methods may be implemented consistent with the present invention for finding the title of a reference within the character string.

The title of the cited reference determined in stage 130 is stored (stage 140). The title may be linked to the character string of the non-patent cited reference. Storage may be in a cited reference database 470 (discussed later). If any more non-patent references are present (stage 150), the other references are analyzed as discussed above at stage 130. If not, if more patents are present in the patent set (stage 160), the next non-analyzed patent is selected (stage 170) and the analysis continues as discussed above at stage 130.

If no further patents are present in the patent set, the number of occurrences of each cited non-patent reference may be counted (stage 180). The results of the count may also be stored, for example, in the cited reference database 470.

The results of the count of non-cited references within the patent set may be provided to the user (stage 190). The result may include providing, for example: the reference most frequently cited in the patent set; the author most frequently cited in the patent set; the count of one or more references in the patent set; and the count of one or more authors in the patent set. The data may also be displayed graphically to the user in, for example, a bar chart.

It will also be appreciated that while the above description focuses on parsing and storing titles, similar methods of parsing could be used to store authors as well in the cited reference database. Thus, author data could also be linked. In addition, the cited reference database 470 may maintain and store the relationship between each patent and each cited reference of the patent, while also maintain other patent information such as, for example, application date, patent classification, and assignee.

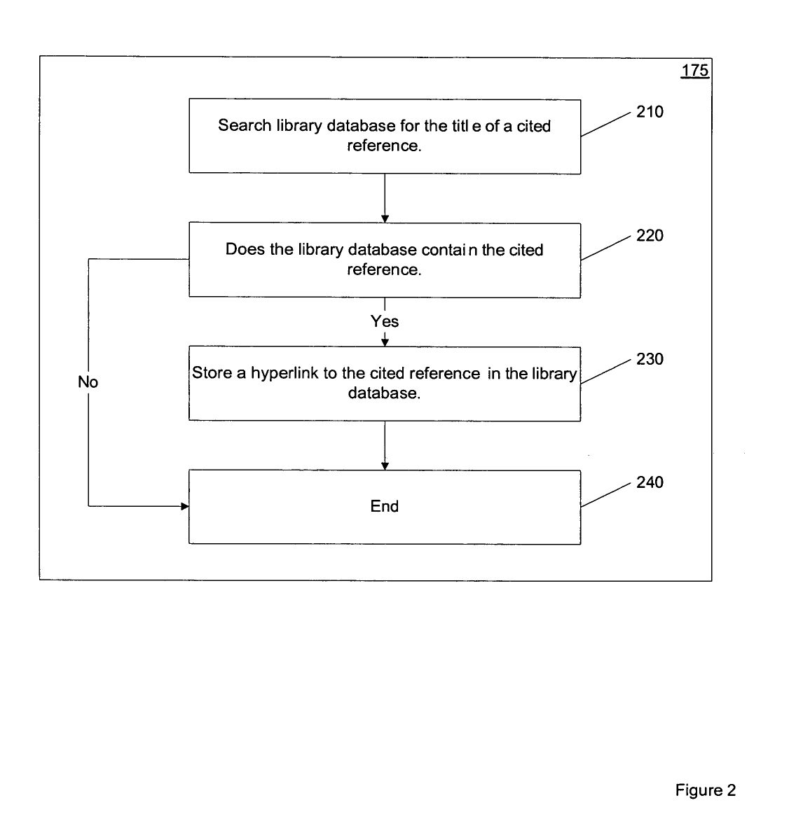

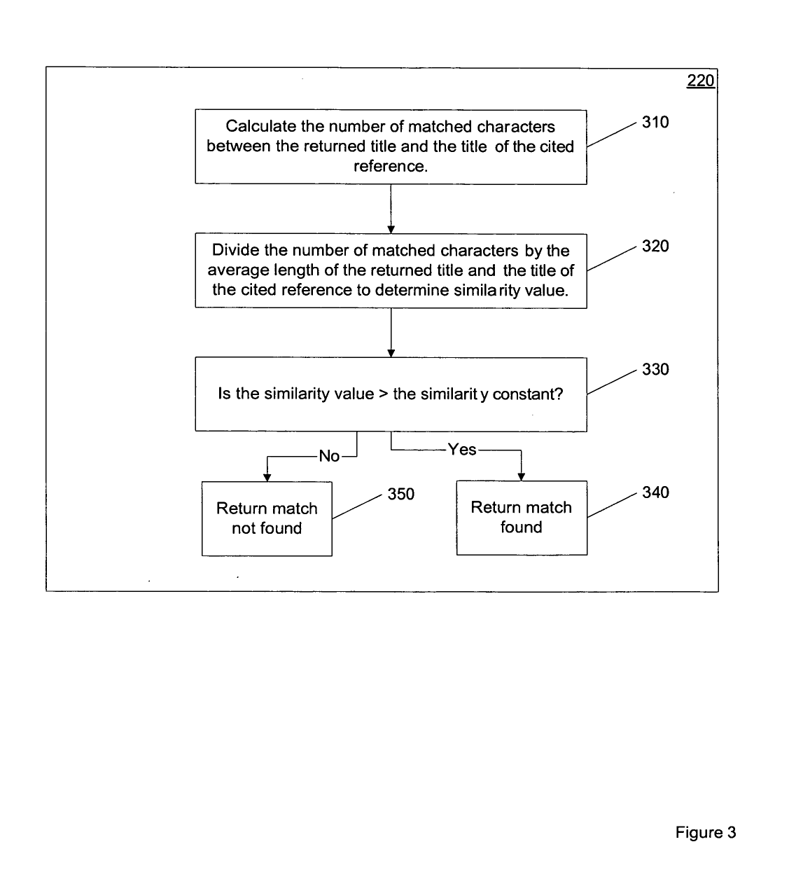

Additionally, the patent analysis method of FIG. 1 may include a library linking process (175) that searches one or more databases of non-patent references and links the non-patent references cited in the patents of the patent set to the actual reference in the one or more databases. FIGS. 2 and 3 illustrate a linking process 175 consistent the principles of the present invention.

FIG. 2 is a flow-chart of a method of linking a reference library consistent with the present invention. A library database 460 (discussed later) may be searched for the title of the cited reference (stage 210). The title of the cited reference may be determined as illustrated in stage 130, or may be gathered from the titles stored in cited reference database 470. When a candidate reference is found in the library database 460, a determination is made as to whether the candidate reference matches the title of the reference (stage 220). This will be discussed in further detail below with reference to FIG. 3. If no match is found, the library link will have failed and no link is established (stage 240). If a match is found, a hyperlink to the cited reference in the library database 470 may be stored in, for example, the cited reference database (stage 230). Thus, library linking process 175 automatically generates hyperlinks to the cited reference, so that a user can easily access the text of the reference.

FIG. 3 is a flow-chart of a character matching method consistent with the present invention. Initially, a comparison is made between the returned title from the library database 470 and the title of the cited reference (stage 310). The comparison calculates the number of characters matched between the two strings. Next, the number of matched characters is divided by the average length of the returned title and the title of the cited reference (stage 320). This yields a fraction that is known as a similarity value. If the similarity value is greater than a similarity constant (stage 330), then a match is found (stage 340). If not, no match is found (stage 350). The similarity constant may be determined by the user or a programmer. For example, the similarity constant may be set, for example, at 0.7, 0.8, or greater.

For example, if the reference title is “core clamps for low voltage technologies” and the returned title is “core clamps for low voltage technology”, the matched length is 32 and the matched part is “core clamps for low voltage technology”. In this example, the matched length is 32 and the average length is 34 (the average of 33 and 35). 32 divided by 34 equals 0.94. The 0.94 value is the similarity. If the similarity constant were set at 0.8, the method 220 would return that a match was found.

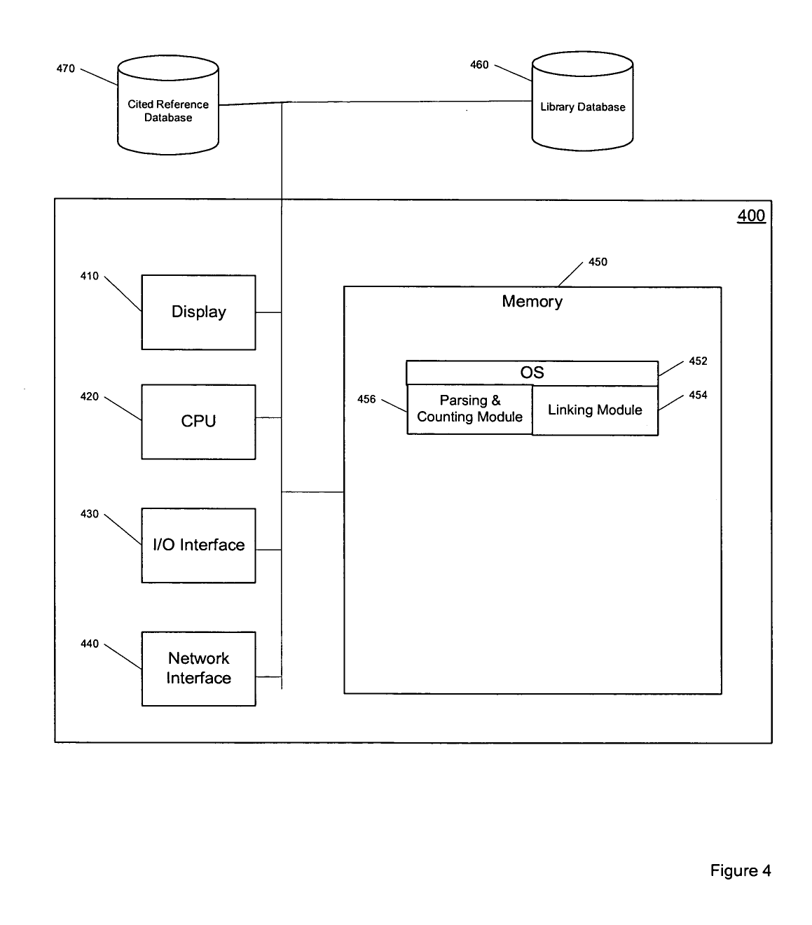

FIG. 4 is a block diagram of a patent analysis platform 400 consistent with the present invention. As illustrated in FIG. 4, a system environment of patent analysis platform 400 may include a display 410, a central processing unit 420, an input/output interface 430, a network interface 440, and memory 450 coupled together by a bus. Patent analysis platform 400 may be adapted to include the functionality and computing capabilities to analyze reference cited in a set of patents.

As shown in FIG. 4, patent analysis platform 400 may comprise a PC or mainframe computer for performing various functions and operations consistent with the invention. Patent analysis platform 400 may be implemented, for example, by a general purpose computer selectively activated or reconfigured by a computer program stored in the computer, or may be a specially constructed computing platform for carrying-out the features and operations of the present invention. Patent analysis platform 400 may also be implemented or provided with a wide variety of components or subsystems including, for example, at least one of the following: at least one central processing units 420, a co-processor, memory 450, registers, and other data processing devices and subsystems.

Patent analysis platform 400 may also communicate or transfer patent information, library database, or cited reference information via I/O interface 430 and/or network interface 440 through the use of direct connections or communication links to other elements of the present invention. For example, a firewall in network interface 440, prevents access to the platform by unauthorized outside sources.

Alternatively, communication within patent analysis platform 400 may be achieved through the use of a network architecture (not shown). In an alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, patent analysis platform 400 may be located in the same location or at a geographically distant location from library database 460 and cited reference database 470.

I/O interface 430 of the system environment shown in FIG. 4 may be implemented with a wide variety of devices to receive and/or provide the data to and from patent analysis platform 400. I/O interface 430 may include an input device, a storage device, and/or a network. The input device may include a keyboard, a microphone, a mouse, a disk drive, video camera, magnetic card reader, or any other suitable input device for providing data to patent analysis platform 400.

Network interface 440 may be connected to a network, such as a Wide Area Network, a Local Area Network, or the Internet for providing read/write access to data in library database 460 and cited reference database 470.

Memory 450 may be implemented with various forms of memory or storage devices, such as read-only memory (ROM) devices and random access memory (RAM) devices. Memory 450 may also include a memory tape or disk drive for reading and providing records on a storage tape or disk as input to patent analysis platform 400. Memory 450 may comprise computer instructions forming: an operating system 452; a parsing and counting module 452 for parsing references in the patent set and counting the references cited; and a linking module 454 for linking cited references to corresponding references in library database 460.

Library database 460 is coupled to patent analysis platform 400. Cited prior art references may be found in library database 460. Library database 460 may comprise, for example, the Science Citation Index (“SCI”) or Social Sciences Citation Index (“SSCI”) databases. Library database 460 may also be a virtual database of references comprising references found through a search engine such as, for example, Google or Google Scholar. Library database 460 may be electronic memory, magnetic memory, optical memory, or a combination thereof, for example, SDRAM, DDRAM, RAMBUS RAM, ROM, Flash memory, hard drives, floppy drives, optical storage drives, or tape drives. Library database 460 may comprise a single device, multiple devices, or multiple devices of multiple device types, for example, a combination of ROM and a hard drive.

Cited reference database 470 is coupled to patent analysis platform 400. A database of tables linking a cited reference to a respective title may be stored in cited reference database 470. Cited reference database 470 may comprise, for example, a spreadsheet as well as a traditional database. Cited reference database 470 may also be stored in memory 450, and not as an external database. Cited reference database 470 may be electronic memory, magnetic memory, optical memory, or a combination thereof, for example, SDRAM, DDRAM, RAMBUS RAM, ROM, Flash memory, hard drives, floppy drives, optical storage drives, or tape drives. Cited reference database 470 may comprise a single device, multiple devices, or multiple devices of multiple device types, for example, a combination of ROM and a hard drive.

Those skilled in the art will appreciate that all or part of systems and methods consistent with the present invention may be stored on or read from other computer-readable media, such as: secondary storage devices, like hard disks, floppy disks, flash storages, CD, or DVD; a carrier wave received from the Internet; or other forms of computer-readable memory, such as read-only memory (ROM), random-access memory (RAM), or magnetic RAM. P Furthermore, one skilled in the art will also realize that the processes illustrated in this description may be implemented in a variety of ways and include multiple other modules, programs, applications, scripts, processes, threads, or code sections that all functionally interrelate with each other to accomplish the individual tasks described above for each module, script, and daemon. For example, it is contemplated that these programs modules may be implemented using commercially available software tools, using custom object-oriented, using applets written in the Java programming language, or may be implemented as with discrete electrical components or as at least one hardwired application specific integrated circuits (ASIC) custom designed just for this purpose.

It will be readily apparent to those skilled in this art that various changes and modifications of an obvious nature may be made, and all such changes and modifications are considered to fall within the scope of the appended claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

We claim:

1. A method for analyzing cited references cited in a patent set comprising two or more patents, the method comprising:
parsing each cited reference cited by each patent to determine a respective title of each respective cited reference;
storing the title of each cited reference and the cited reference in a cited reference database, where the cited reference database links the respective title with the respective cited reference;
counting the occurrence of each cited reference in the cited reference database; and
displaying the title of the cited reference with the highest count.

2. The method of claim 1, further comprising, prior to parsing each cited reference, receiving the patent set comprising two or more patents.

3. The method of claim 1, further comprising displaying the number of times the cited reference with the highest count was cited.

4. The method of claim 1, further comprising displaying the respective titles of one or more cited references not having the highest count.

5. The method of claim 1, further comprising displaying the author with the highest count.

6. The method of claim 5, further comprising displaying the count of the author.

7. The method of claim 4, further comprising displaying the number of times each of the respective one or more cited references was cited.

8. The method of claim 1, further comprising:
searching a library database for the title of one of the cited references;
determining whether the library database contains the cited reference; and
if the library database contains the cited reference, storing a hyperlink to the cited reference that is in the library database.

9. The method of claim 8, wherein the hyperlink is stored in the cited reference database linked to the title of the one of the cited references.

10. The method of claim 8, wherein determining whether the library database contains the cited reference comprises determining the similarity between a returned title from the search of the library database and the title of the one of the cited references.

11. The method of claim 10, wherein determining the similarity between a returned title from the search of the library database and the title of the one of the cited references comprises:
calculating the number of matched characters between the returned title and the title of the one of the cited references;
dividing the number of matched characters by the average length of the returned title and the title of the one of the cited references to determine a similarity value;
if the similarity value is greater than a similarity constant, then providing the result that the library database contains the cited reference.

12. The method of claim 11, where the similarity constant is greater than or equal to about 0.8.

13. A system for analyzing cited references cited in a patent set comprising two or more patents, the system comprising:
a memory;
a processor coupled to the memory, the processor operable to:
parse each cited reference cited by each patent to determine a respective title of each respective cited reference;
store the title of each cited reference and the cited reference in a cited reference database, where the cited reference database links the respective title with the respective cited reference;
count the occurrence of each cited reference in the cited reference database; and
provide the title of the cited reference with the highest count.

14. The system of claim 13, the processor further operable to, prior to parsing each cited reference, receive the patent set comprising two or more patents.

15. The system of claim 13, wherein the processor is further operable to provide the number of times the cited reference with the highest count was cited.

16. The system of claim 13, wherein the processor is further operable to provide the respective titles of one or more cited references not having the highest count.

17. The system of claim 16, wherein the processor is further operable to provide the number of times each of the respective one or more cited references was cited.

18. The system of claim 13, wherein the processor is further operable to:
search a library database for the title of one of the cited references;
determine whether the library database contains the cited reference; and
if the library database contains the cited reference, store a hyperlink to the cited reference that is in the library database.

19. The system of claim 18, wherein the hyperlink is stored in the cited reference database linked to the title of the one of the cited references.

20. The system of claim 18, wherein the processor determines whether the library database contains the cited reference by determining the similarity between a returned title from the search of the library database and the title of the one of the cited references.

21. The system of claim 20, wherein the processor determines the similarity between a returned title from the search of the library database and the title of the one of the cited references by:
calculating the number of matched characters between the returned title and the title of the one of the cited- references;
dividing the number of matched characters by the average length of the returned title and the title of the one of the cited references to determine a similarity value;
if the similarity value is greater than a similarity constant, then providing the result that the library database contains the cited reference.

22. The system of claim 21, where the similarity constant is greater than or equal to about 0.8.

23. The system of claim 13, wherein the processor is further operable to provide the author with the highest count.

24. The system of claim 23, wherein the processor is further operable to provide the count of the author.
